(19) United States
(12) Patent Application Publication
(10) Pub. No.: US 2015/0208671 A1
(43) Pub. Date: Jul. 30, 2015

(54) HIGH FIBER FOOD ITEMS

(71) Applicant: Edward Daniel SCHMIDT, Richfield, MN (US)

(72) Inventor: Edward Daniel SCHMIDT, Richfield, MN (US)

(21) Appl. No.: 14/524,965

(22) Filed: Oct. 27, 2014

Related U.S. Application Data
(60) Provisional application No. 61/959,521, filed on Aug. 27, 2013.

(51) Int. Cl. A21D 2/36

(52) U.S. Cl. CPC A21D 2/36; A21D 2/362

(57) ABSTRACT

A composition for making high fiber white panned bread by the USDA definition comprising 100 parts by weight of cereal grain flour and a premix that includes 22 parts of pea hull fibers, wheat bran and gum acacia with a ratio of pea hull fibers to wheat bran being in the range of 3.3:1 and a range of pea hull fiber to gum acacia being 7.71:1. In one embodiment, the premix is for bread making is in an amount of about 22 parts by weight of a bread formula. The premix comprises pea fiber, wheat bran and gum acacia.

### CROSS-REFERENCE TO RELATED APPLICATION

This application claims the benefit under 35 U.S.C. §119(e) of U.S. Provisional Patent Application No. 61/959,521 filed on 27 Aug. 2013, the contents of which are incorporated here by reference in their entirety. A claim of priority is made.

### TECHNICAL FIELD

Various embodiments described herein relate to and high fiber food items and methods for making high fiber food items.

### BACKGROUND OF THE INVENTION

There are many fiber breads on the market today made from such things as whole wheat, flax seeds, microcrystalline cellulose (wood) etc. U.S. Pat. No. 4,237,170 to Satin discloses using yellow and green pea hulls to formulate a bread having the color, texture and flavor of white bread with the fiber and nutritional content of whole wheat bread. This was done through the addition of 5 to 20 parts by weight of pea hulls ground to particle size what will pass through 20-80 mesh screen inclusively. Satin found pea fiber ground to a smaller than 80 mesh screen size undesirable for bread making contributing an off color, aroma and flavor. Bread formulated by Satin did not survive in the market place due to an off aroma and flavor remaining in the loaves.

Comer (U.S. Pat. No. 4,301,179) found that the bitter flavor can be removed from pea flour by contacting the flour with steam while the Moscow Food IND. INST. patent (USSR Pat. No. 867,353) describes a method for hydrothermally treating (pre-cooking) peas to improve bread quality when peas are added to bread formulations at the 5-20% level. Both patents relate to the production of and application of pea powder. Tsantir U.S. Pat. No. 3,767,423) developed a low calorie bread through a finely divided mixture of rice hulls and soy bran hulls.

In U.S. Pat. No. 4,109,018 to Thompson, there is disclosed a low calorie bread made from a dough composed of from 100 parts by weight of wheat flour including a 3-9 parts of protein material selected from low fat soy flour, nonfat dry milk, dried yeast flour, cotton seed fiber and 10-20 parts alpha cellulose flour. Thompson reduced the calorie content by raising the fiber content.

Levin (U.S. Pat. No. 7,252,850) relates to the development of high protein and high fiber food products, the fiber content being raised by adding about any fiber source at the 5-97% level by weight. Levin teaches the addition of numerous gums. Surprisingly, we have found a specific blend of ingredients results in a concentrate that imparts superior organoleptic properties as well as a high fiber product.

Schmidt (U.S. Pat. No. 4,711,786) relates to a high fiber bread, or edible extruded product, that is formulated from wheat flour, pea flour and advantageously includes two or more of isolated pea protein, ground triticale hulls and ground pea hulls. Schmidt discovered a bread product higher in fiber than whole wheat but not high fiber by government standards. In U.S. Pat. No. 8,354,137, Atwill outlines the procedure for producing a bread higher in fiber but does not present a specific high fiber bread formula a baker can work with.

No current bread bakery items that can be labeled high fiber as defined by the FDA (bread must contain 5 grams of fiber for 2 slices weighting 50 grams). There is also a problem encountered obtaining the desired organoleptic qualities, people will not eat bread for dietary purposes alone. Most fibers inhibit the dough from developing and inpart an off flavor. For example, the ever popular whole wheat kernel has an acid tasting aleurone layer.

### SUMMARY OF THE INVENTION

Fiberich Lite® Concentrate is Just What The Doctor Ordered. Fiberich Lite Concentrate is a premix that includes 22 parts of pea hull fibers, wheat bran and gum acacia with a ratio of pea hull fibers to wheat bran being in the range of 3.3:1 and a range of pea hull fiber to gum acacia being 7.71:1. In one embodiment, the premix is for bread making is in an amount of about 22 parts by weight of a bread formula. The premix comprises pea fiber, wheat bran and gum acacia. The premix can be mixed with various types of flours to form bread, pasta, snacks, and the like. For example, the premix can be mixed with flour to form a composition for making high fiber white panned bread by the USDA definition comprising 100 parts by weight of cereal grain flour. Medical, health and nutritional experts agree that there is a strong relationship between a high fiber diet and good overall health.

Cancer. Foods rich in fiber is one of the four dietary recommendations to lower risk of cancer. Diets high in dietary fiber and low in fat inhibit colon/rectal cancer. Diet is thought to be a major epidemiological factor in colon cancer.

Heart Disease. The American heart Association recommends a higher carbohydrate diet, important to reduce the risk of coronary disease.

Control and Management of Diabetes. The American Diabetic Association recommends eating high levels of dietary fiber to produce the smallest rise in blood glucose. High fiber appears to improve receptor sensitivity to insulin, lowering blood sugar and insulin requirements. The fiber found in legumes (dried peas and beans) is rated the highest of all bran containing foods.

Obesity. A diet high in dietary fiber aids in weight loss and is an ideal therapeutic measure for management of obesity because high fiber diets lowers overall caloric intake. “Dietary Fiber fills you up, not out!”

Constipation/diverticulitis/IBS (Irritable Bowel Syndrome). Dietary fiber (soluble and insoluble) is the most effective long-term remedy for eliminating constipation and preventing diverticulitis. It has also been linked with the reversal of IBS, which effects many Americans.

There are an increasing number of foods on the market containing edible fiber. However, no current bakery items that can be labeled high fiber as defined by the FDA (Bread must contain 5 grams of fiber for 2 slices weighting 50 grams). Breads formed with various flours which are combined with the above mentioned premix or concentrate meet the FDA's definition for high fiber. Bread made from the premix or concentrate and white flour also overcome the problem encountered where most fibers inhibit the dough from developing and inpart an off flavor. For example, processing flour into white wheat flour removes the acid tasting aleurone layer can inhibit the dough from developing and inpart an off flavor.

### BRIEF DESCRIPTION OF THE DRAWINGS

FIG. 1 is a schematic diagram showing a mixture of premix and flour, according to an example embodiment.

FIG. 2 is a method for forming products, according to an example embodiment.

### DETAILED DESCRIPTION

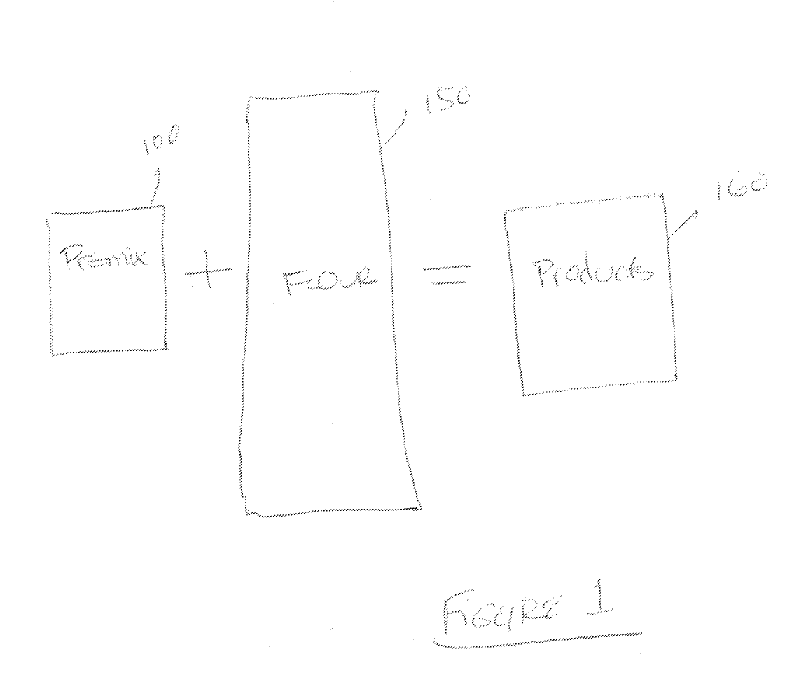

FIG. 1 is a schematic diagram showing a mixture of premix 100 and flour 150, according to an example embodiment. The premix 100 can also be termed concentrate. The terms are used interchangeably in this description. The flour 150 can be any type of flour. It should be noted that the invention is not limited with respect to the type of flour used. As discussed below, the premix or concentrate 100 is mixed with white flour, corn flour or any other type of cereal based flours. The flour 150 and the premix 100 are mixed and formed into a dough or other material. This is then used to form other products 160, such as bread, corn snakes, or other products.

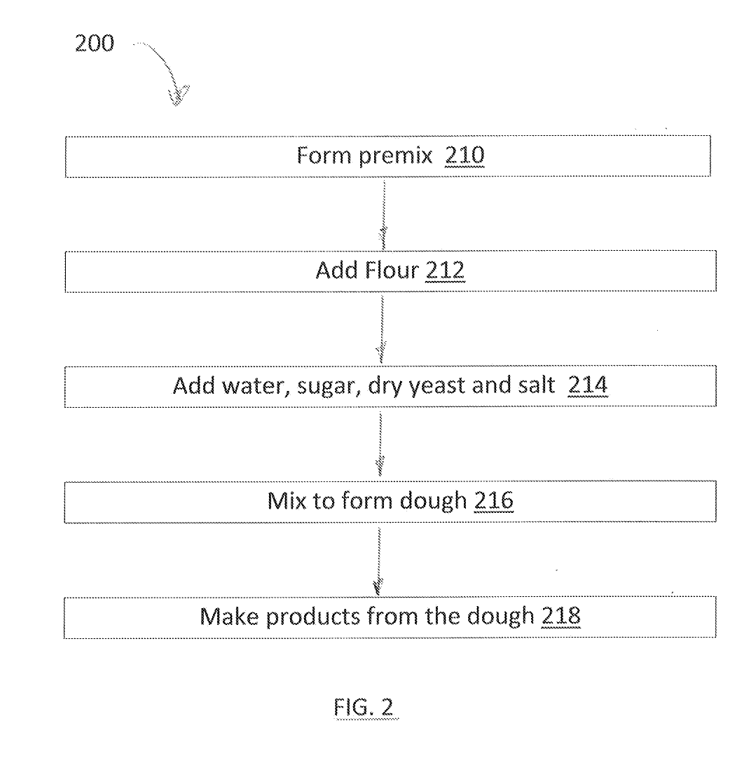

FIG. 2 is a method 200 for forming products, according to an example embodiment. As shown, the method 200 includes preparing the premix or concentrate 210, adding flour 212, and adding other ingredients 214. The other ingredients can include dry yeast, water, sugar, and salt. The ingredients are mixed to form a dough 216. The dough is then formed into various high fiber products 218. The high fiber products include bread, snacks, flat bread, pasta, extruded items and the like. The premix or concentrate 100 allows one to form the high fiber products.

The premix or concentrate 100 includes of a mixture of the pea hull milled, wheat bran milled and gum acacia.

A spherical pea has a thin outer shell (or hull) having about 85% total dietary fiber, wheat bran 45% total dietary fiber and gum acacia 85% total dietary fiber.

While peas are available green (chlorophyll) and yellow (xanthophyll), the color of the pea has little effect on the color of the hull. Hulls from the yellow or green peas can be used interchangeably.

Gum Acacia is a natural gum containing 85% soluble fiber (dry basis) and is the hardened sap taken from two species of the acacia tree. It is available in about a +/−60 mesh screen size, depending upon the manufacturer.

Mesh comes in many sizes. One of the standards for mesh are determined by the Tyler scale. Mesh sized according to the type scale are referred to as Standard Mesh. Screen sizes for the pea fiber and what bran used in the bread formulation for the first embodiment of the invention is as follows:

| | | |
|---|---|---|
| Tyler Screens | Pea Fiber | Wheat Bran |

| | | |
|---|---|---|
| −200 | 12.4% | 13.7% |
| −100 | 20.9% | 20.7% |
| −80 | 27% | 23.3% |
| −60 | 35.3% | 31.45% |
| −20 | 95.8% | 99.3% |

Any differences in size distribution for both the fiber and bran will differ due to the manufacturer of the hammermill, or pulverizer. Wheat bran is harder to mill than pea fiber, it tends to bend not break, resulting in greater differences in size distribution.

### First Embodiment

A first embodiment of a premix used to produce our high fiber bread includes ingredients as follows:

Pea Hulls (ground as specified)

Wheat Bran (ground as specified)

Gum Acacia (ground as specified)

Some sources of a concentrated finely ground soluble fiber can be added in place of the gum acacia.

Sources of any 85% fiber blend can be added to achieve the required fiber level but will not impact the desired organoleptic properties.

The preferred premix used to produce our high fiber bread consists of the following blend of ingredients.

| | |
|---|---|
| Pea Hulls (ground as specified) | 70% |
| Wheat Bran (ground as specified) | 21% |
| Gum Acacia (ground as specified) | 9% |
| | 100% |

The concentrate can be added to most white bread formulas, a typical example, in bakers percentage is (bread formula #1)

| | |
|---|---|
| White patent flour | 100% |
| Concentrate | 22% |
| Water | 74% |
| Sugar | 6% |
| Dry yeast | 2% |
| Salt | 2.5% |

Percentage of yeast, dry or cake form, normally added to white bread formulas, would apply here.

It was found that making one batch of the bread following bread formula #1 and replacing the bread flour and wheat bran with whole wheat flour, two completely different products were obtained. The desired results were obtained following the bread formula #1.

The less concentrate added to the formula, the less the percentage of fiber is added to the bread and the less desireable the organoleptic properties become.

Product is offered in the form of a concentrate, incorporated into a dry bread mix (minus the shortening and yeast) as well as the complete white bread mix in the form of a frozen dough modifications normally made in frozen dough formulas, such as the addition of an oxidizing agent, can be made prior to freezing the dough.

The concentrate works well with most natural ingredients but clashes with some artificial enhances. For example, pea flour (a natural constituent in the pea fiber mix) will not tolerate the addition of 1-cysteine, 1-cysteine reduces mixing times as does pea flour. However, the baker can make normal adjustments to the formulation such as the addition of mold inhibitors, yeast food and non-fat dry milk without changing the spirit of the invention.

The concentrate can be added to increase the fiber content of most flour based food items including pasta, snack foods, cereals, extruded items, flat breads and the like.

### Second Embodiment

Premix Concentrate #2

Peal Hulls 70-73% (grounded as specified)

Wheat Bran 19-30% (grounded as specified)

Gum Acacia 2-11% (grounded as specified)

The concentrate can be added to increase the fiber content and enhance the organoleptic properties of most milled meal based products including bread, pastas, snack foods, cereals, extruded items, flat breads and the like.

For example, patent flour can be replaced with other cereal grain flours such as semolina to form a pasta. Legume based flours are preferred to eliminate gluten. However, lack of gluten will result in flat bread.

The product where patent flour is replaced with corn flour resulting in a corn based snack item.

Some sources of concentrated soluble fiber can be added in place of gum acacia but care must be taken. For example, inulin is an excellent source of soluble fiber but can cause gastro intestine distress.

Minor adjustments can be made in the bread however formula #1, above, is preferred.

Gluten content of the flour may vary whether its inherent in the flour or added in the form of vital wheat gluten.

Bleached, bromated, enriched flour, or variations there in, may be added.

The amount of water added may vary depending upon the absorption of the mix.

The amount of shortening added will vary depending upon the softness of the item (bread vs rolls vs buns vs sweet goods and the like.

A composition for making high fiber white panned bread by the USDA definition comprising 100 parts by weight of cereal grain flour and a premix that includes 22 parts of pea hull fibers, wheat bran and gum acacia with a ratio of pea hull fibers to wheat bran being in the range of 3.3:1 and a range of pea hull fiber to gum acacia being 7.71:1. In one embodiment, the premix is for bread making is in an amount of about 22 parts by weight of a bread formula. The premix comprises pea fiber, wheat bran and gum acacia. The pea fiber is in an amount of 70% by weight of the premix. The wheat bran is in an amount of 21% by weight of the premix and gum acacia being in an amount of 9% of the premix. In another embodiment, the pea hull fibers, wheat bran and gum acacia are of sizes that will pass through a 20 mesh screen. At least 14% of the pea hull fibers and wheat bran will pass through a 200 mesh screen, and 100% of the gum acacia will pass through a 200 mesh screen. The pea hulls, contains about 85% fiber, the wheat bran contains about 45% fiber and gum acacia contains about 85% fiber. The flour formed is a wheat flour. To make bread, a dough is made from the wheat flour including this composition and shaped and baked to form a bread product. In another embodiment, the flour is either other cereal grain flours, legume based flours or corn flours. In this embodiment, the dough is made and used to form a pasta, snack items, extruded cereals items, flat bread and the like.

A method for making extruded items, such as pasta, snack items, cereals and the like includes using cereal grain flour with pea hull fibers, wheat bran and gum acacia being about 22 parts by weight per 100 parts of flour and a ratio of pea fiber and wheat bran being a range of about 3.3:1 and the range of pea fiber to gum acacia being 7.7:1. In one embodiment, the 100 parts of cereal grain flour are replaced with legume flours to form a flat bread. In another embodiment, the cereal grain flour is semolina and this is used to form a pasta product. In another embodiment, the cereal grain flour is corn flour and it is used to produce a corn flavored snack.

A composition for making a high fiber white pan bread includes 100 parts by weight of wheat flour, about 74% water, 6% sugar, 6% shortening, 1.1% dry yeast, 2.5% salt and about 22 parts by weight of a premix of pea hull fibers, wheat bran and gum acacia. In one embodiment, the premix includes at least 70% by weight of the pea hull fibers, 21% by weight of the wheat bran and 9% by weight of gum acacia. In one embodiment, the composition is characterized in that pea hull fiber, wheat bran and gum acacia are sized to pass through a 20 mesh screen and at least 14% of the pea hull fibers and wheat bran will pass through a 200 mesh screen, and 100 percent of gum acacia will pass through a 200 mesh screen. The ratio of pea hull fibers to wheat bran is in the range of 3.3:1 and a range of pea fiber to gum acacia is 7.71:1. A dough can be formed using the above compositions. The dough is shaped to form a bread. In one embodiment, the pea fiber is 15:4 parts by weight, wheat bran is 4.62 parts by weight, gum acacia 1.98 parts by weight of the wheat flour. Of course, it is to be understood that minor adjustments can be made in the concentrate providing a high fiber bread with good organoleptic properties. In yet another embodiment, the composition is for the making of bread. The premix is an amount of 22% of a typical bread formula including pea fiber, wheat bran and gum acacia, the pea fiber being an amount of from 70-73% of the premix, the wheat bran being 19-30% of the premix and gum acacia being 2-9% of the premix. In another embodiment, the composition is further characterized in that pea hull fibers, wheat bran and gum acacia are sizes that will pass through a 200 mesh screen and at least 14% of the pea hull fibers and wheat bran will pass through a 200 mesh screen, and 100% of the gum acacia will pass through a 200 mesh screen. The ratio of pea hull fibers to wheat bran is from 3.84:1 to 2.3:1 and ratio of pea hull fibers to gum acacia 36.5:1 to 7.77:1. A dough is made from the premix discussed above shaped to form a bread. The composition can also be used for making extruded items (pasta, snack items, cereals, flat bread and the like). The premix is an amount of 22% of a typical extruded item formula includes pea fiber, wheat bran and gum acacia, the pea fiber being an amount from 70-73% of the premix, the wheat bran being 19-30% of the premix and gum acacia being 2-9% of the premix. The pea hull fibers, wheat bran and gum acacia are sized to pass through a 200 mesh screen and a at least 14% of the pea hull fibers and what bran will pass through a 200 mesh screen, and 100% of the fum acacia will pass through a 200 mesh screen. The ratio of pea hull fibers to wheat bran is from 3.84:1 to 2.3:1 and the ratio of pea hull fibers to gum acacia is in a range of 36.5:1 to 7.77:1. The product can be used with semonlina cereal grain flour. This can be used to produce pastas of all types. The product can also be used with corn flour and used to make corn flavored snacks.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description

1. A composition for making high fiber white panned bread comprising 100 parts by weight of cereal grain flour and a premix that includes 22 parts of pea hull fibers, wheat bran and gum acacia with a ratio of pea hull fibers to wheat bran being in the range of 3.3:1 and a range of pea hull fiber to gum acacia being 7.71:1.

2. The composition of claim 1 where in the premix is for bread making in an amount of about 22 parts by weight of a typical bread formula and consists of pea fiber, wheat bran and gum acacia, the pea fiber being an amount of 70% by weight of the premix, the wheat bran being 21% by weight of the premix and gum acacia being in an amount of 9% of the premix.

3. The composition of claim 1 further characterized in that pea hull fibers, wheat bran and gum acacia are of sizes that will pass through a 20 mesh screen and at least 14% of the pea hull fibers and wheat bran will pass through a 200 mesh screen. 100% of the gum acacia will pass through a 200 mesh screen.

4. The composition of claim 1 where the pea hulls contain about 85% fiber, the wheat bran contains about 45% fiber, and gum acacia contains about 85% fiber.

5. The composition of claim 1 where the cereal grain flour is a wheat flour, the composition used to make a dough which is shaped and baked to form a bread product.

6. The composition of claim 1 where in the cereal grain flour is a corn flour, the composition used to make a dough which is shaped and baked to form a snack item.

7. A method for making extruded items comprising of cereal grain flour with pea hull fibers, wheat bran and gum acacia being about 22 parts by weight per 100 parts of flour and a ratio of pea fiber and wheat bran being a range of about 3.3:1 and the range of pea fiber to gum acacia being 7.7:1.

8. The method of claim 7 wherein the extruded item is a pasta product.

9. The method of claim 7 wherein the extruded item is a snack item.

10. The method of claim 7 wherein the extruded item is a cereal.

11. The method of claim 7 where 100 parts of cereal grain flour are replaced with legume flours to form a flat bread.

12. The method of claim 7 where the cereal grain flour is semolina and the product is pasta.

13. The method of claim 7 where the cereal grain flour is corn flour and the product is a corn flavored snack.

14. A composition for making a high fiber white pan bread comprising 100 parts by weight of wheat flour, about 74% water, 6% sugar, 6% shortening, 1.1% dry yeast, 2.5% salt and about 22 parts by weight of a premix of pea hull fibers, wheat bran and gum acacia.

15. The composition of claim 14 where the premix includes at least 70% by weight of the pea hull fibers, 21% by weight of the wheat bran and 9% by weight of gum acacia.

16. The composition of claim 14 characterized in that pea hull fiber, wheat bran and gum acacia are sizes that will pass through a 20 mesh screen and at least 14% of the pea hull fibers and wheat bran will pass through a 200 mesh screen, and 100 percent of gum acacia will pass through a 200 mesh screen.

17. The composition of claim 14 where the ratio of pea hull fibers to wheat bran is in the range of 3.3:1 and a range of pea fiber to gum acacia is 7.71:1.

18. The composition of claim 14 where pea fiber is about 15.4 parts by weight, wheat bran is 4.62 parts by weight, gum acacia 1.98 parts by weight of the wheat flour.

19. The composition of claim 14 where in it is for the making of bread, the premix is an amount of 22% of a typical bread formula consisting of pea fiber, wheat bran and gum acacia, the pea fiber being an amount of from 70-73% of the premix, the wheat bran being 19-30% of the premix and gum acacia being 2-9% of the premix.

20. The composition of claim 19 where in the ratio of pea hull fibers to wheat bran is from 3.84:1 to 2.3:1 and ratio of pea hull fibers to gum acacia 36.5:1 to 7.77:1.
